(19) United States
(12) Patent Application Publication
(10) Pub. No.: US 2009/0199004 A1
(43) Pub. Date: Aug. 6, 2009

(54) SYSTEM AND METHOD FOR SELF-AUTHENTICATING TOKEN

(76) Inventors: Mark Stanley Krawczewicz, Annapolis, MD (US); Daniel Ricciotti, Annapolis, MD (US); Jeffrey Minushkin, Great Falls, VA (US)

Correspondence Address: 24IP LAW GROUP USA, PLLC, 12 E. LAKE DRIVE, ANNAPOLIS, MD, 21403, US

(21) Appl. No.: 12/363,859

(22) Filed: Feb. 2, 2009

Related U.S. Application Data
(60) Provisional application No. 61/025,088, filed on Jan. 31, 2008.

(51) Int. Cl. H04L 9/32

(52) U.S. Cl. 713/172

(57) ABSTRACT

A secure token, possibly in the form of a smartcard, has a smart window with smart materials such as an electrophoretic or an electrochromic layer or assembly. When authenticated, such as by using biometrics or a password, the smart window layer is electronically pulsed, thereby transforming the once opaque layer to transparent and revealing information printed under, on or over the layer, or vice versa, transforming once transparent laminate to opaque and obfuscating printed information. In another embodiment, when the smart window layer is electronically pulsed to transform the once opaque laminate to transparent, a timer is started. At the end of a certain amount of time, the smart window layer is pulsed a second time, thereby transforming the layer back from transparent to opaque.

### CROSS-REFERENCE TO RELATED APPLICATIONS

The present application claims the benefit of the filing date of U.S. Provisional Patent Application Ser. No. 61/025,088 filed by the present inventors on Jan. 31, 2008.

The aforementioned provisional patent application is hereby incorporated by reference in its entirety.

### STATEMENT REGARDING FEDERALLY SPONSORED RESEARCH OR DEVELOPMENT

None.

### BACKGROUND OF THE INVENTION

1. Field of the Invention

The present invention relates to systems and methods for secure authentication using a smart token.

2. Brief Description of the Related Art

A variety of systems and methods for secure authentication using a token have been used in the past. Such smart tokens may be in the form of smartcards, USB tokens or other forms. Conventional smartcards typically are credit-card sized and made out of flexible plastic such as polyvinyl chloride. Smartcards have been used in wide varieties of applications, such as identification badges, membership cards, credit cards, etc. Conventional USB tokens are typically small and portable and may be of any shape. They typically are embedded with a micromodule containing a silicon integrated circuit with a memory and a microprocessor.

Smartcards can be either “contact” or “contactless.” Contact cards typically have a visible set of gold contact pads for insertion into a card reader. Contactless cards use radio frequency signals to operate. Other smart tokens connect to other devices through a USB or other communications port.

Smart cards typically may have information or artwork printed on one or both sides of the card. Since smart cards are typically credit card sized, the amount of information that may be displayed on a smartcard is typically limited. A number of efforts have been made to increase the amount of data that may be displayed on a smartcard. For example, U.S. Pat. No. 7,270,276 discloses a multi-application smartcard having a dynamic display portion made, for example, of electronic ink. The display on that card changes from a first display to a second display in response to an application use of the smartcard. Another example is U.S. Patent Publication Serial No. US2005/0258229, which disclosed a multi-function smartcard (also known as an “integrated circuit card” or “IC card”) with the ability to display images on the obverse side of the card.

### SUMMARY OF THE INVENTION

The present invention generally is a secure token in the form of a smartcard, USB device, identity badge, or other personal token. In one embodiment of the invention, the secure token connects either wired or wirelessly to mobile devices such as MP3 music/video players, cellular phones, PDA's, laptops, other mobile devices, retail point of sales terminals, kiosks, etc. When connected together and in concert with such other device, the invention provides a method for the sole purpose authentication of the parties and facilitating secure transactions. The secure transactions may be, but are not limited to, secure financial or commercial transactions, secure access control, or secure currency transactions or exchanges.

In a preferred embodiment, the present invention is a secure token that comprises a substrate layer having an interface therein, a tamper layer comprising a conductive tamper pattern, a flex circuit layer comprising a microprocessor, a memory, a timer and a battery, the memory, timer, tamper pattern and interface being connected to the microprocessor and the timer being connected to the battery, and a smart window layer having a transparent state and an opaque state, wherein the smart window layer changes between the transparent and opaque states with the application of a voltage. The secure token may further comprise a transparent PVC layer having information printed thereon and the a portion of the printed information is at least partially obscured when the smart window layer is in the opaque state and is visible when the smart window is in the transparent state. Still further, the smart window may comprises a plurality of window sections, each window section being independently controllable to switch between transparent and opaque states and wherein information printed on portions of the PVC layer overlying each window section is visible when the window section is in its transparent state and is at least partially obfuscated when the window section is in its opaque state.

In another preferred embodiment, the present invention is a secure token such as a smart card. The secure token comprises a substrate layer having an interface therein, a tamper layer comprising a conductive tamper pattern such as a serpentine pattern, a flex circuit layer comprising a microprocessor, a memory, a timer and a battery, the memory, the tamper pattern and the interface being connected to the microprocessor and the battery, and a smart window layer having information printed thereon, wherein a portion of the information printed thereon may be at least partially obfuscated or revealed by the application of a voltage to the smart window. The secure token additionally may further comprise a holographic layer having a holograph thereon.

The smart window may comprise one window or a plurality of window sections and may comprise, for example, an electrophoretic or electrochromic material. Each window section may be independently controllable to switch between transparent and opaque states and wherein information printed on each window section is visible when the window section is in its transparent state and is at least partially obfuscated when the window section is in its opaque state. The smart window may further comprise means for creating a visible void in the smart window layer.

The flex circuit layer may further comprise a timer, the timer being started when the smart window layer is changed from an opaque state to a transparent state and when the timer reaches a predetermined threshold, the smart window layer is automatically changed from the transparent stated to the opaque state.

The microprocessor may comprise means for sending a pulse through the conductive tamper pattern and means for detecting a pulse sent through the tamper pattern. The microprocessor further may comprise an encryptor/decryptor, and/or the secure token may further comprise an encryptor/decryptor connected to the battery and the microprocessor.

The secure token may further comprise a biometric sensor mounted to the secure token and connected to the microprocessor. The biometric sensor may comprise, for example, a fingerprint reader.

In another preferred embodiment, the present invention is a secure token that comprises a housing, a window layer on a portion of the housing, the window layer having a substantially transparent state and a substantially opaque state, and means for controlling the window layer to change between the transparent and opaque states. The window layer at least partially obfuscates printed data when the laminate is opaque and does not obfuscate the printed data when the laminate is in the transparent state. The printed data may be printed on the window layer such that it is over the window layer or may be printed on the housing such that it is under the window layer. The secure token may further comprise means for performing authentication within the secure token, such as with a fingerprint reader or other biometric sensor. The secure token may further comprise a battery for providing power to the microprocessor, the window layer and the means for performing authentication. The means for authenticating may comprise a fingerprint reader, which may be mounted on the housing, in a recess in the housing, or mounting to a lower layer in the assembly and protrude through openings in overlying layers. The secure token may be, for example, in the shape of a credit card and has front and back sides. The secure token may further comprise an interface such as an RFID interface, a USB port, and a 30-pin bipod type connector, and a six-pin smartcard interface.

Still other aspects, features, and advantages of the present invention are readily apparent from the following detailed description, simply by illustrating preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIGS. 1(a)-(h) are diagrams illustrating a secure token in the form of a smartcard or smartbadge in accordance with various preferred embodiments of the present invention.

FIG. 2 is a block diagram of the system architecture of a smartcard secure token in accordance with a preferred embodiment of the present invention.

FIG. 3(a) is a diagram illustrating a first layer of a secure token in the form of a smartcard or smartbadge in accordance with a preferred embodiment of the present invention.

FIG. 3(b) is a diagram illustrating a second layer of a secure token in the form of a smartcard or smartbadge in accordance with a preferred embodiment of the present invention.

FIGS. 3(c) through 3(f) are diagrams illustrating a third layer of a secure token in the form of a smartcard or smartbadge in accordance with a preferred embodiment of the present invention.

FIGS. 3(g)-(i) are diagrams illustrating a fourth layer of a secure token in the form of a smartcard or smartbadge in accordance with a preferred embodiment of the present invention.

FIG. 4(a) is a diagram illustrating of a fifth layer of a secure token in the form of a smartcard or smartbadge in accordance with a preferred embodiment of the present invention.

FIG. 4(b) is a diagram illustrating five layers of a secure token in the form of a smartcard or smartbadge in accordance with a preferred embodiment of the present invention.

FIG. 5 is a cross sectional view of an smart window layer in accordance with a preferred embodiment of the present invention.

FIG. 6 is a cross-sectional view of an alternate embodiment of a secure token in accordance with the present invention.

FIG. 7(a) is a flow diagram illustrating authentication and operation of a secure token in accordance with a preferred embodiment of the present invention.

FIG. 7(b) is diagram illustrating hardware authentication between a secure token and a reader in accordance with a preferred embodiment of the present invention.

FIG. 8 is a top perspective view of a USB secure token in accordance with a preferred embodiment of the present invention.

FIG. 9 is a block diagram of a USB secure token in accordance with a preferred embodiment of the present invention.

### DETAILED DESCRIPTION OF THE PREFERRED EMBODIMENTS

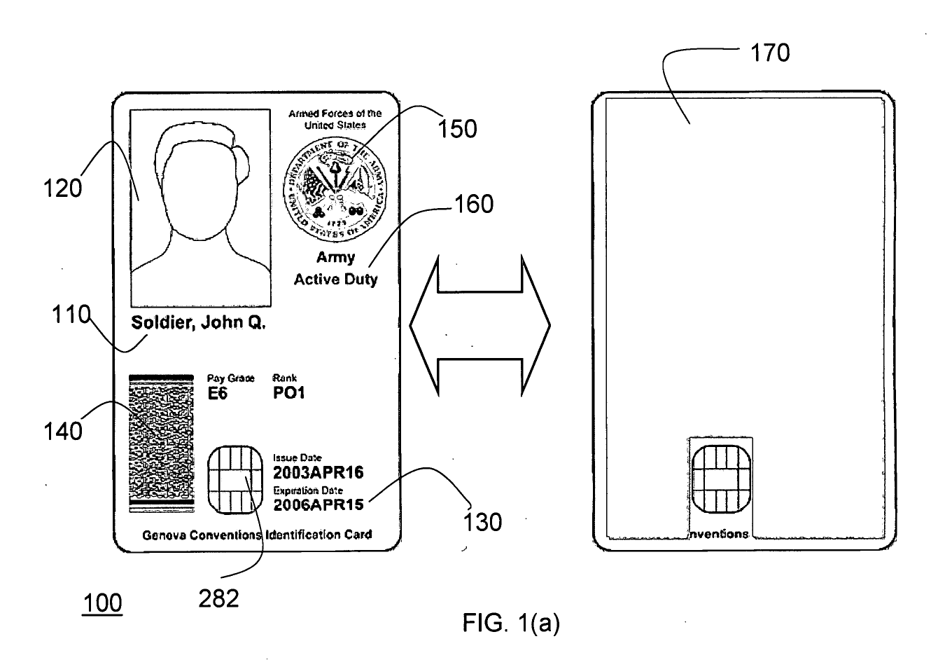

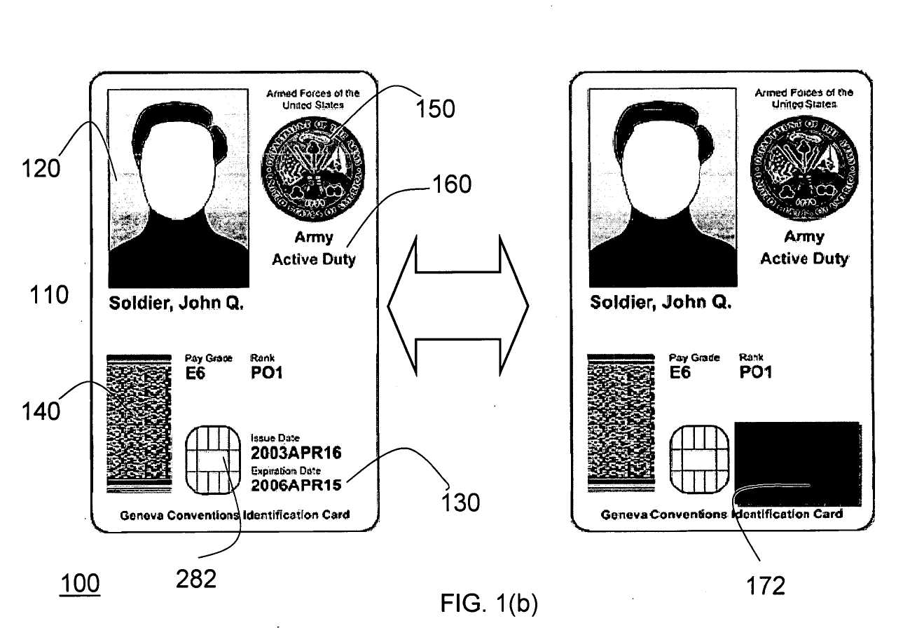

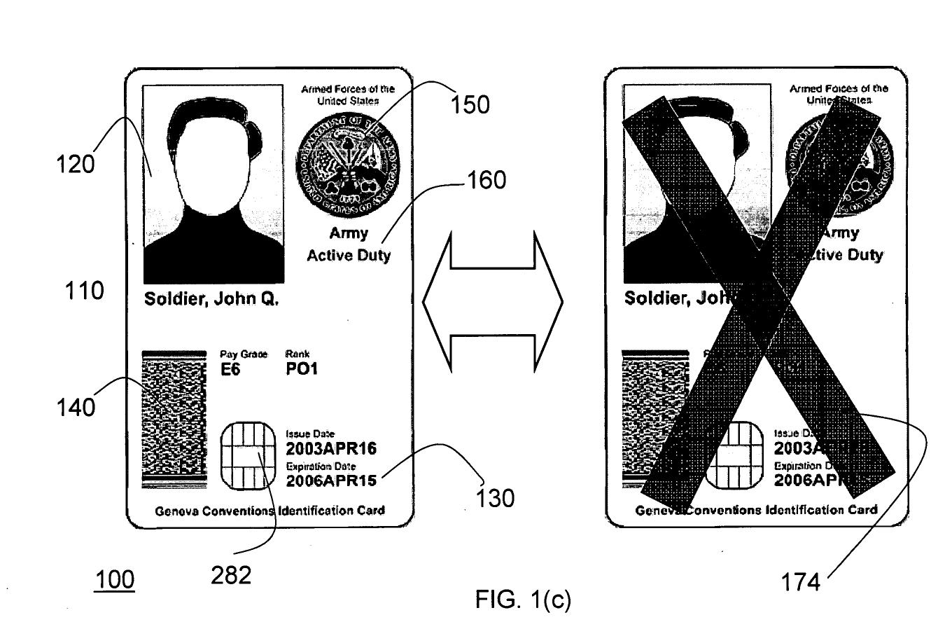

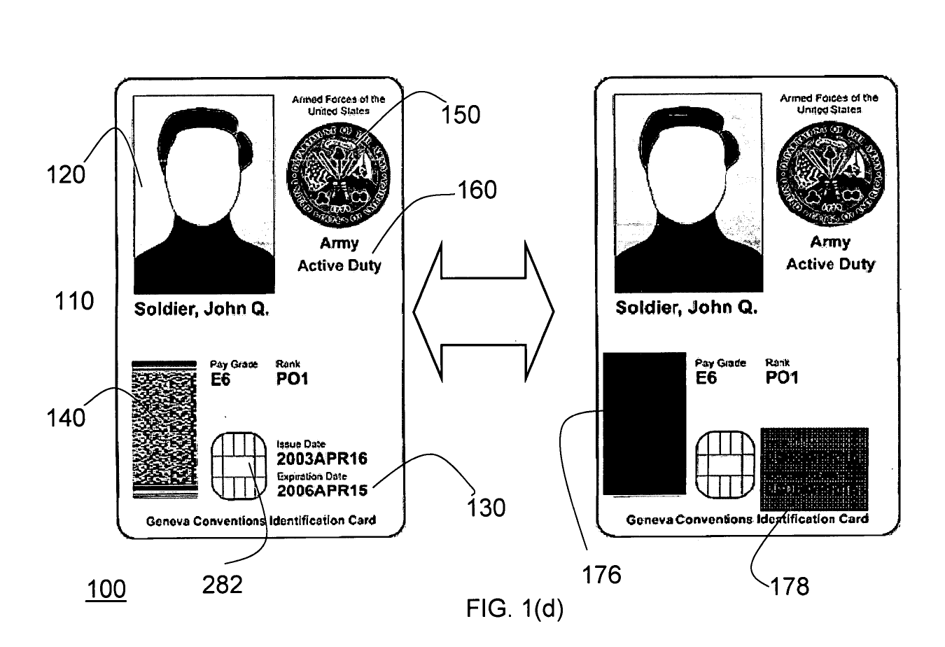

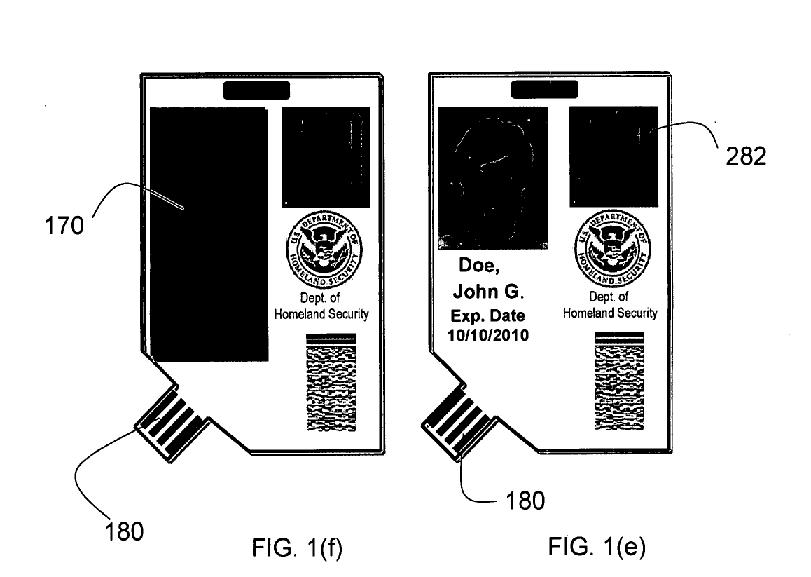

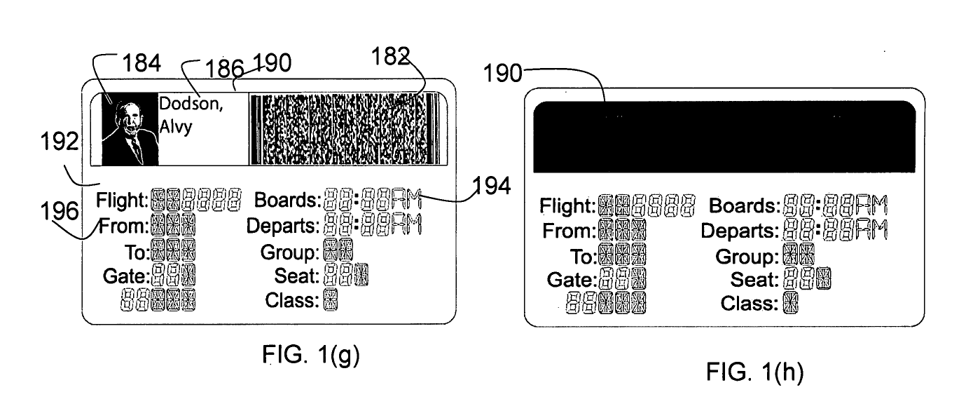

As shown in FIG. 1(a)-(c), a smartcard 100, which may be a badge, credit card, driver's license, frequent flyer card or identification of any other type has one or more types of information printed thereon. The information may be of any type, for example, a name 110, photo 120, expiration date 130, bar code 140, logo 150, or affiliation 160. Many other types of information may be used and such variations will be apparent to those of skill in the art. A portion (or all) of the smartcard 170, referred to herein as a “window,” can be selectively obfuscated. While it may be desirable in some embodiments to completely obfuscate the print such as is shown in FIG. 1(a) when the card is in an “inactive” state, it is not necessary to completely obfuscate the print in other embodiments. Rather, in such other embodiments the window need only have the ability to provide a visual indication that the card is in an “inactive” or unauthenticated state, such as is shown in FIG. 1(c). Further, while only a single window is shown in FIGS. 1(a)-1(c), other embodiments may have a plurality of independently controlled windows, such as is shown in FIG. 1(d).

Another embodiment of a secure token in accordance with the present invention is shown in FIGS. 1(e)-(f). In this embodiment, the secure token is in the form of a smartcard having a USB 180 connector formed at one corner of the card. The smart window 170 and fingerprint sensor 282 also are shown.

In other embodiments, the present invention may take the form of smart badges or cards for use in security applications such as in airports, business, government facilities, or anywhere in which security systems may be desirable. With the present invention, an individual may be issued a badge, card or token that may be activated and deactivated under desired circumstances. For example, the badge, card or token might be issued to a traveler who has undergone advance security clearing. When the badge holder goes through security in an airport, for example, the badge is authenticated by a reader that places the badge in an “active” or “approved” state once the badge-holder's identity is confirmed. The badge remains in an active state for some pre-determined period of time and then automatically returns to an inactive state until the traveler's next trip. The invention similarly could be used as an employee identification card in which the badge is placed into an “active” or “approved” stated when the employee arrives or “clocks in” and then remains active or approved for some predetermined period of time, such as an eight hour shift, after which the badge automatically returns to an inactive state. In a preferred embodiment of the invention, the badge will have some type of visible indicator, such as obfuscation of particular information on the badge, when the badge is in an inactive or “sleep” state. It should be understood that many variations, such as having information obfuscated while the card is active and visible while inactive, are also possible with the present invention.

An example of such an embodiment is shown in FIGS. 1(g)-(h). A smartbadge or card, which may be a badge, cleared traveler card, credit card, driver's license, frequent flyer card or identification of any other type has one or more types of information printed thereon. The information may be of any type, for example, a name 182, photo 184, expiration date or time, bar code 186, logo, or affiliation. Other information of course may be used. A portion (or all) of the smartcard, identified as area 190 in FIGS. 1(g) and (h), is a smart window. With this smart window, a portion (or all) of the face of the card can be visible or at least partially obfuscated depending on the state of the material. The printed information may be under the material or over the material, provided that changes in the state of the material provide visible indicators. In FIG. 1(g), the material is in a transparent state such that the information in area 190 is plainly visible. In FIG. 1(h), the material is in an opaque state such that the printed information is obfuscated either partially or completely, thereby providing a visible indication that the card is in an “inactive” or “unauthenticated” state. As shown in FIGS. 1(g) and (h), the card may further have additional information 192, part of which may be modifiable, such as with a LEDs. For example, a card may include printed labels 184 such as “Flight”, “From,” “To,” “Gate,” “Group,” “Seat,” “Class,” “Boards,” “Departs,” or any other label and may have programmable or changeable date 196 such as a flight number, origination city, arrival city, gate number, boarding time, departure time, group number, seat number, class or any other useful information. In the embodiment shown in FIGS. 1(g) and (h), the smartbadge is used as a cleared traveler card such that information regarding the travelers itinerary is displayed on the card once the card is authenticated.

In one embodiment, the window 170 has a layer having an electrochromic material. (see, for example, Chao Ma, Minoru Taya and Chunye Xu, “Smart Sunglasses and Goggles Based on Electrochromic Polymers”) or an electrophoretic material. In such an embodiment, the electrochromic or electrophoretic layer is placed over (or on) the print on the card such that the print is partially or totally obfuscated when the electrochromic polymer is in one state and the print in the window is viewable when the electrochromic polymer is in a different state. In another embodiment, an electrophoretic material, layer or assembly is behind the print and at least partially obfuscates the print when in one state and leaves the print visible when in a different state. Other types of thin film technology, such as clorestic or bistable twisted-nematic, also are possible and may be used with the present invention.

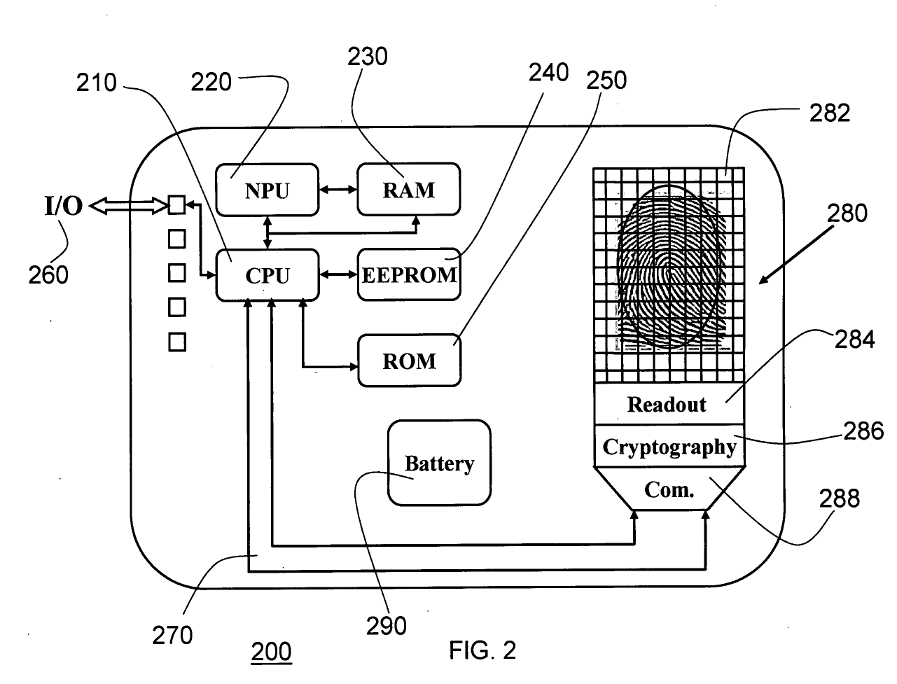

A preferred embodiment of a system architecture for a secure token in the form of a smartcard or smartbadge is described with reference to FIG. 2. The smartcard 200 has a CPU 210 connected to a bus 270. NPU 220, RAM 230, EEPROM 240 and RAM 250 are connected to the CPU 210. Biometric sensor 280, which has a reader 282, readout 284, cryptography 286 and com 288 is connected to bus 270.

While cryptography 286 is shown in FIG. 2 as part of the fingerprint reader, cryptography 286 may be incorporated into or be performed by a separate chip or by the microprocessor to securely protect cryptographic keys to encrypt the data and/or applications on the smartcard. The cryptography chip or microprocessor may be powered by the battery to hold and protect the keys. The cryptography chip or microprocessor may, for example, zeroize the cryptography keys if a tamper event occurs, if the user fails to authenticate a certain number of times, or the user wants to manually zeroize the keys.

In a preferred embodiment, all of the electronic components of the smartcard are powered by a thin film battery 290. In other embodiments, electrical power and signaling is provided through a 6-pin smart card standard 7816 contact interface to some or all of the components. Under the application of a predetermined external power, the self-authentication process is executed within the circuitry of the device using firmware programmed in the microprocessor 210.

When the smartcard is authenticated, in this embodiment by a user pressing a finger against reader 282, the window layer is electronically pulsed, thereby transforming the once opaque layer 170 to transparent and revealing underlying or overlying printed information 110, . . . 160, or vice versa, transforming once transparent laminate to opaque and obfuscating underlying or overlying printed information. While the window layer 170 shown in FIG. 1(a) covers substantially all of the printed data on the card, other embodiments are possible in which only portions of the data, such as an expiration date or account number, are obscured by the opaque window layer 172, as shown in FIG. 1(b), (c) and (d).

In other embodiments, when the electrochromic layer or the electrophoretic layer is electronically pulsed to transform the once opaque layer to transparent, a timer is started. The timer may be within the CPU 210 or may be a separate element. At the end of a certain amount of time, the electrochromic or electrophoretic layer or assembly is pulsed a second time, thereby transforming the material back from transparent to opaque. In this manner, the card can be authenticated or activated for any desired period time. At the conclusion of a set time period, such as an eight hour shift, the window layer is pulsed to transform the layer from transparent to opaque and thereby indicate that the card is no longer active or authenticated. The same procedure would be used for other types of window layers.

In these preferred embodiments, the biometric sensor is a fingerprint reader, but it will be apparent to those of skill in the art that other types of sensors or input devices for inputting biometric data, PINs, or passwords may be used with the present invention. In still other embodiments, a smartcard or smartbadge may be authenticated by means other than a sensor or input device on the card itself. For example, if a smartbadge were being used as a work identification card at an airport or hospital, the badge could be authenticated through a reader when the employee begins a shift such that all pertinent data is revealed during the shift. At the end of the shift, some or all of the data could be obscured thereby indicating visually to anyone seeing the card that the card was not valid at that time. In this manner, a lost or stolen identification card would be worthless and unusable.

In one secure token embodiment, an additional thin film plastic windowing layer is placed above the top external plastic layer. Two electrical contact pads are disposed at in appropriate locations on the bottom surface of the windowing layer to electrically connect to corresponding contact pads to establish a physical electrical connection when assembled.

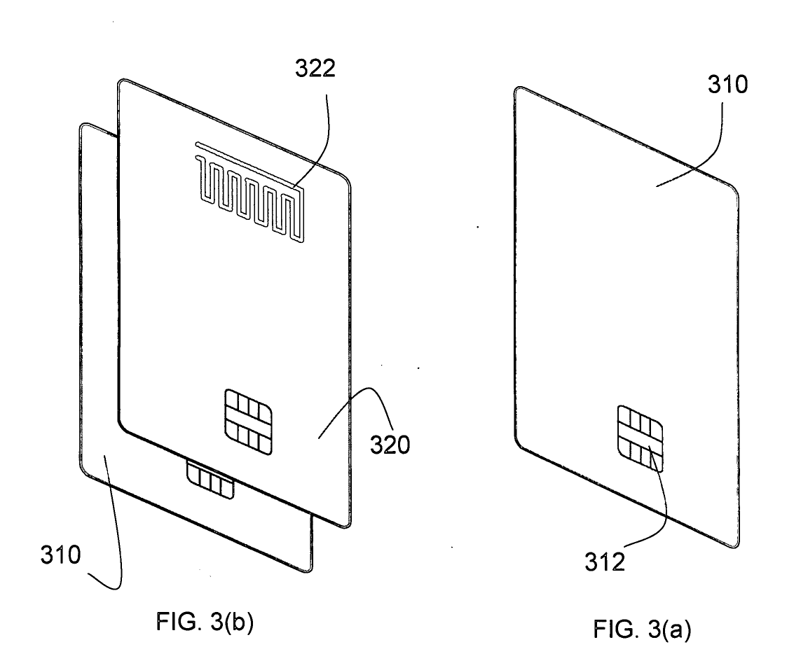

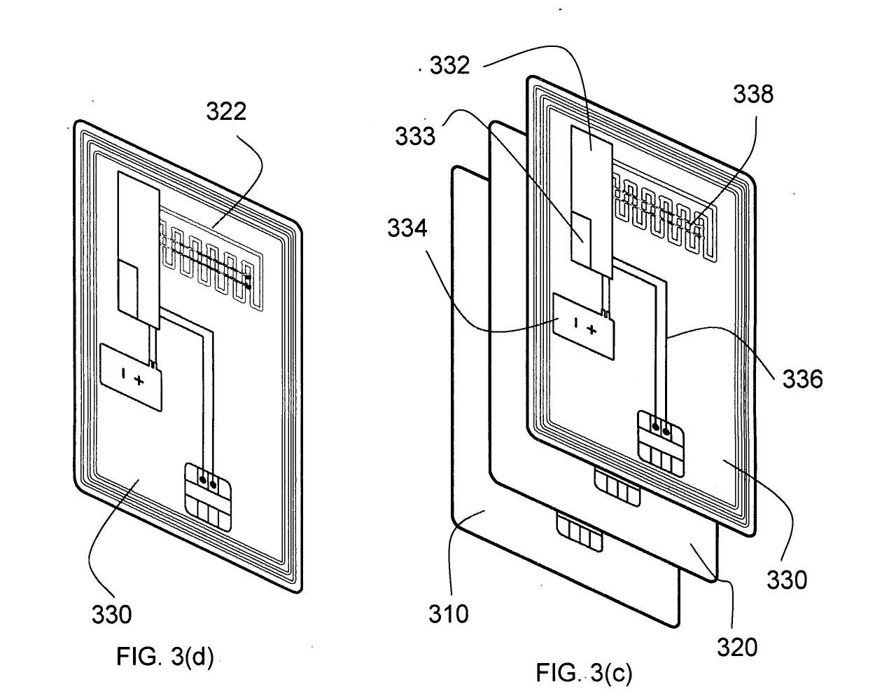

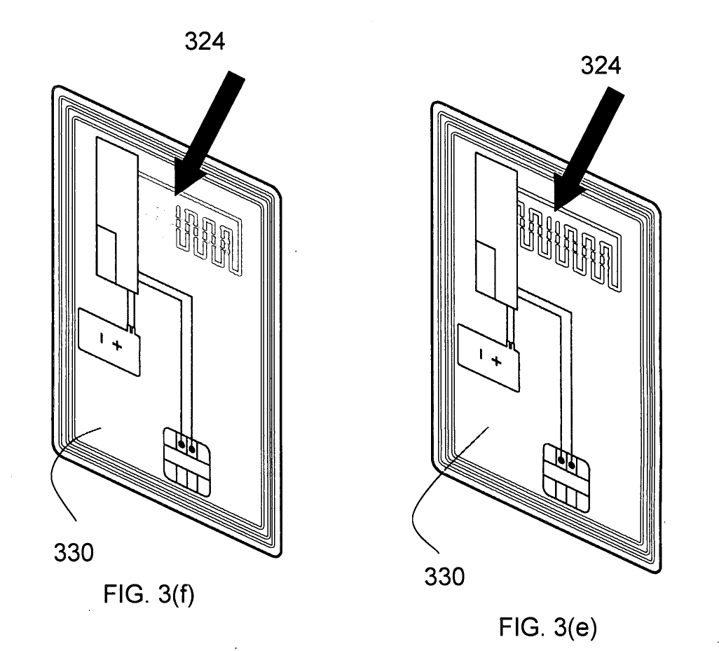

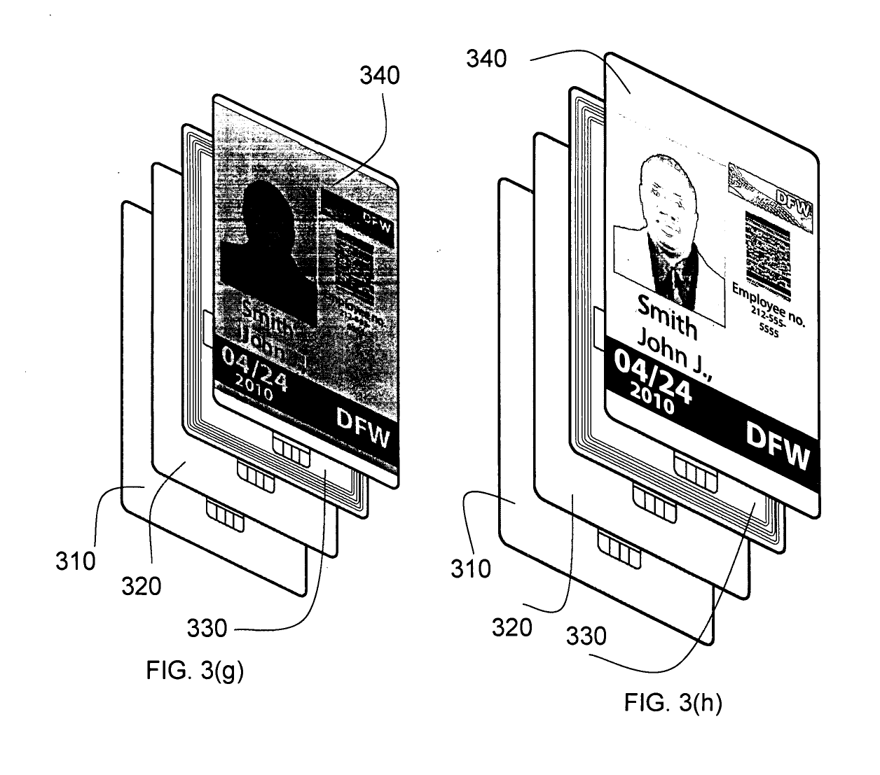

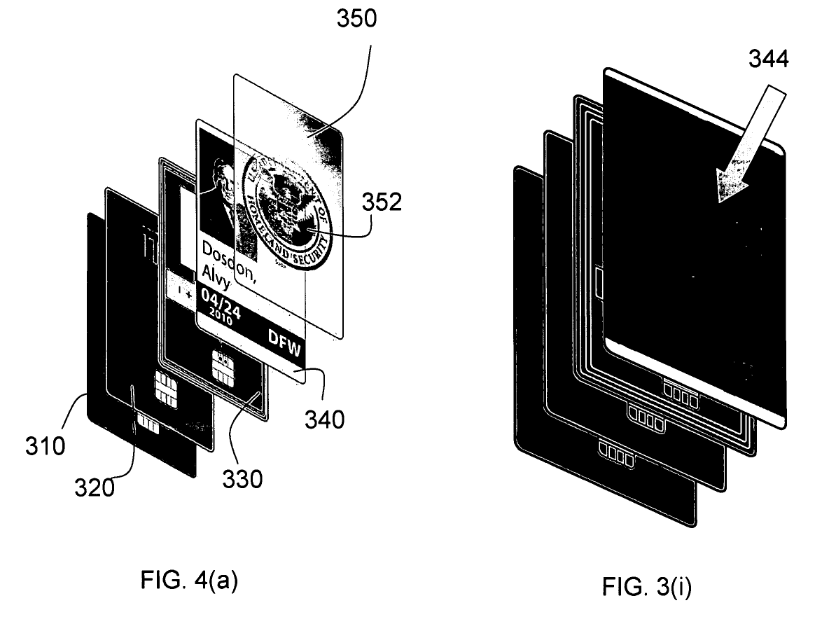

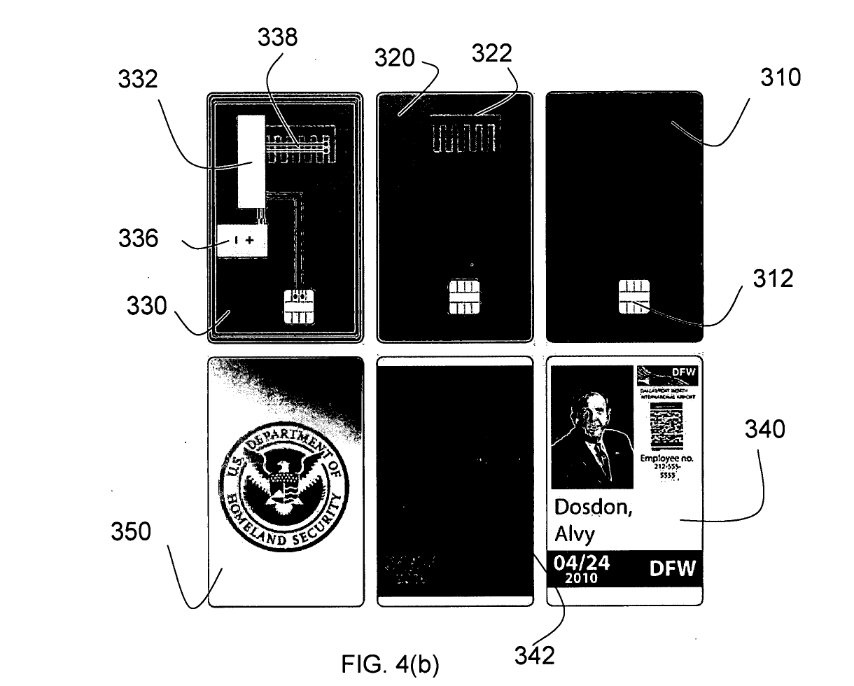

A preferred embodiment of a smartcard or smartbadge in accordance with the present invention is described with reference to FIGS. 3-4. As shown in FIG. 3(a), the card has a plastic substrate layer 310 having, for example, a 6-pin smart card standard 7816 contact interface 312. Other types of contacts, such as a 30-pin connector, USB, WiFi, Bluetooth, RFID, and IEEE 802.11x in various embodiments of the invention.

As shown in FIG. 3(b), the card next has a tamper layer 320 having a serpentine pattern 320 therein. The serpentine pattern 320 connects to the next layer, a flex circuit layer 330, shown in FIG. 3(c).

The flex circuit layer 330 has a microprocessor CPU 332, a protected memory 333, a thin-film battery 334, lines 336 connected to the smartcard contact 312, and connections 338 to the serpentine pattern 312 in the tamper layer 310. All data in and out of the card is fully encrypted.

In a preferred embodiment, all of the electronic components of the smartcard are powered by a thin film battery 334. In other embodiments, electrical power and signaling is provided through the smart card interface 312. Under the application of a predetermined external power, the self-authentication process is executed within the circuitry of the device using firmware programmed in the microprocessor 332. When a card is being authenticated, the processor 332 will send a pulse through the serpentine pattern 312. When the serpentine pattern is intact as shown in FIG. 3(d), the pulse travels through the serpentine layer 312 and back to the microprocessor 332. If the card has been tampered with, a gap 324 will appear in the serpentine layer 312, as shown in FIG. 3(e). When the microprocessor 332 sends a pulse through the serpentine layer 312 in the tampered with card, the pulse stops at the break 324 in the serpentine layer, as shown in FIG. 3(f).

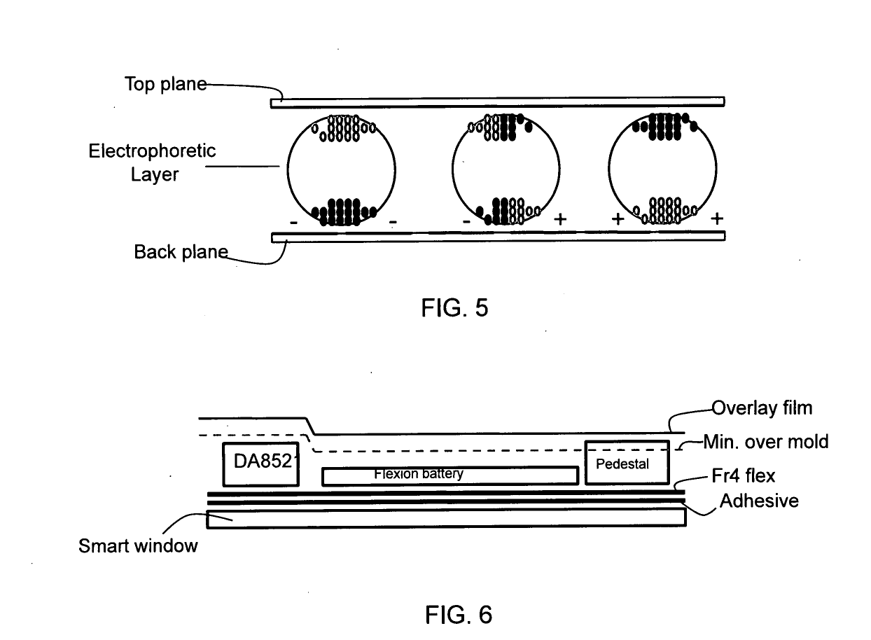

A smart window layer 340 is on the flex circuit layer 330. As shown in FIG. 5, the smart window layer 340 may be, for example, an electrophoretic layer or assembly comprised of a back plane, a top plane, and an electrophoretic material positioned in between the two. In a preferred embodiment, the bottom plane is an electrical circuit layer and the top plane is a transparent conductive plastic layer. In one embodiment, the transparent conductive plastic of the smart window layer 340 has information printed thereon, some of which can be obfuscated as shown in FIG. 3(g) when the laminate is placed in a first state and then revealed as shown in FIG. 3(h) when the laminate is changed to a second state. In other embodiments, an additional transparent printing layer such as transparent PVC is placed on the window layer and information is printed on the transparent printing layer. As an additional security measure, the card may be designed such that a visible void 344 appears in the switching material when the smart window layer is tampered with, as shown in FIG. 3(i). In embodiments having a plurality of windows, each window has a separate contact or contacts that are used by the CPU to control the state (transparent or opaque) of the window.

As shown in FIGS. 4(a) and (b), the badge further may have an additional security layer 350 having, for example, a hologram 352 thereon. A fingerprint reader (shown in FIGS. 1-2) is mounted onto the card after deposition of the final layer. In a preferred embodiment, the contacts for the fingerprint reader pass through the upper layers of the card and are soldered to the contact 312 from the back. Alternative arrangements, such as having the fingerprint reader connected to the bus also are possible and will be apparent to those of skill in the art.

The secure tokens may be manufactured using a variety of different methods. Preferred methods including reactive injection molding and cold lamination.

In another embodiment shown in FIG. 6, the circuit elements (chip DA 8521) are arranged on one side of the card such that the flex circuit layer may be, for example, only half the width of the card. With such an arrangement, the card may be thicker on the flex circuit layer side and thinner on the other side such that a magnetic strip may be placed on the back of the card on the thin side to permit the thin part of the card to be swiped through conventional magnetic strip swipers, such as at an ATM. Other arrangements to achieve various thicknesses are of course possible.

In another preferred secure transaction embodiment, a secure token in a plastic card form is inserted through a card reader assembly. The card reader makes electrical connections between the secure card token contacts and the portable mp3 player or other device input connector. The card reader assembly contains a slot to receive the secure card token with sufficient depth and width to make electrical contact with surface contacts to corresponding and matching electrical contacts located inside the card reader assembly. In a similar manner, the card reader contacts are electrically connected to corresponding and appropriate pads on a connector, which insert into a connector on the commercial portable mp3 or similar device. In such an embodiment, a PIN may be required for authentication in addition to the biometric data (such as a fingerprint). The reader and the card may be mutually authenticating.

In embodiments in which the smart card preferably is thin, the size of the battery 336 can be critical. In such embodiments, the required battery size may be reduced through a variety of techniques. For example, electrical power and signaling may be provided through a contact, such as a 6-pin smart card standard 7816 contact interface, to all components other than the timer while the timer is powered by the thin-film battery 336. Further, the card may have a driver circuit or chip to generate a pulse to change the state of the window layer. Such a driver circuit may for example have a charge pump comprising a plurality of capacitors. In this way, a smaller battery may be used to pulse the window layer.

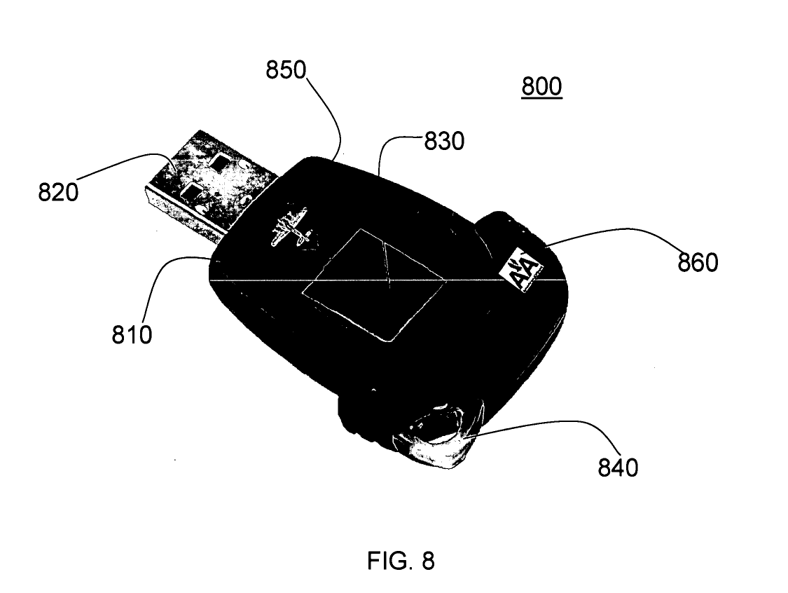

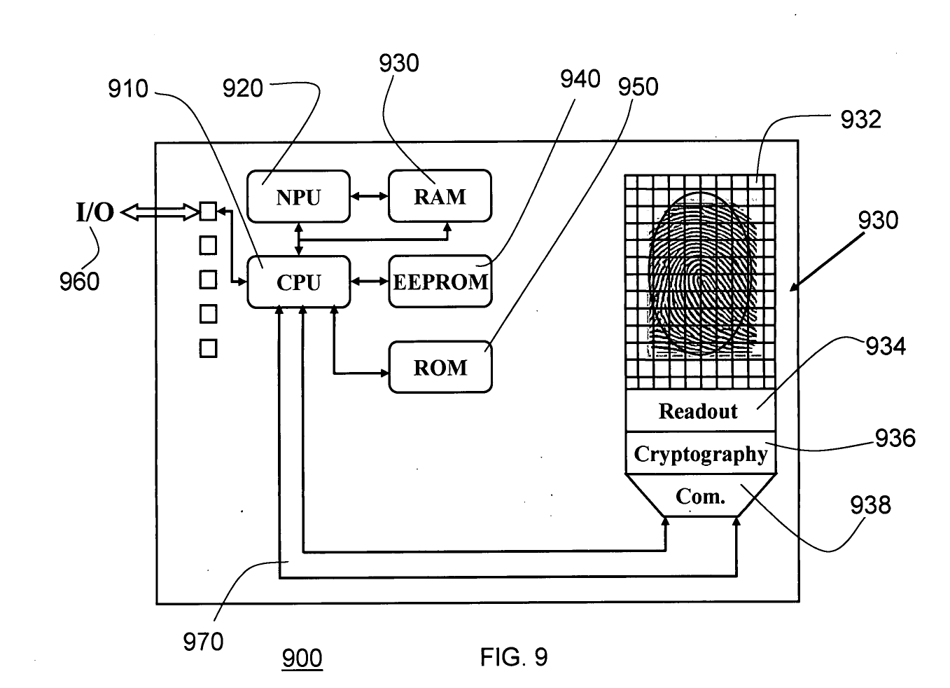

An embodiment of a self-authenticating token for insertion into a mobile device such as a MP3 player, video player, PDA, cellular phone, laptop, control station, retail point of sales terminal, kiosk, ATM or similar devices for secure transactions is described with reference to FIGS. 8-9. In this embodiment, the token 800 has a housing 810 having a communications port 820 at one end. The housing has a recess in which there is an input device 830, which preferably is a biometric sensor such as a fingerprint scanner. The sensor preferably has a rectangular shape with the longer length oriented perpendicular to the connector, but other shapes and arrangements are possible. The housing additionally has a convenience mechanism 840. The housing 810 may be of any size, shape or color, may be made of any convenient material such as the plastic shown in FIG. 8, and may or may not have indicia such as logos 850, 860 printed or formed thereon. The communications port 820 similarly may be of any type, such as a USB port 820 as shown in FIG. 8 or any other known communications port. For example, the port may be a 30-pin bipod type connector, which includes USB and Firewire interface.

An input device 830 provides the user with an area to place their finger or thumb directly in contact to the biometric sensor. The sensor preferably has a rectangular shape from the top view but may be of other shapes. In FIG. 8, the input device 830 is a fingerprint scanner, but may be other any of a variety of other types for inputting biometric data, passwords, PINs, or other authenticating data.

A preferred embodiment of a system architecture for the token is described with reference to FIG. 9. The token 900 has a CPU 910 connected to a bus 970. NPU 920, RAM 930, EEPROM 940 and RAM 950 are connected to the CPU 910. Biometric sensor 930, which has a reader 932, readout 934, cryptography 936 and com 938 is connected to bus 970.

Under the application of a user presenting a biometric proof such as their fingerprint (or a password or PIN) to the secure token, the user's identity is validated on the internal circuitry residing within the token. This circuitry compares the users presented fingerprint scanned on the sensor to the stored sensor residing in electronic memory with in the secure token.

Under the application of inserting the portable secure token to the commercial mobile device, the secure token may provide the control signal to initiate the user authentication process and apply electrical power as the pinning source to execute the authentication algorithm.

Biometric fingerprint imaging sensor 980, captures a grey scale image of the user's fingerprint and converts the image into a digital bit stream. A microprocessor 910 in the token generates a reference orientation, converts the grey scale digital image into a binary, thins ridge structure to a single bit, then extracts the unique features such end point and branch points to a vector based minutia set. This minutia vector is compared to a pre-stored minutia vector or template by an algorithm executed on the microprocessor 910.

Upon the user successfully matching a statistical pre-determined threshold between the stored and user's scanned finger placed on fingerprint sensor, data stored in protected memory within the secure token is cryptographically unlocked for further access. Data stored in protected memory can vary depending on application however; preferable data is cryptographic certificates, barcode images for export to portable mobile devices.

An alternative to the communications port is a wireless interface, preferably 802.11x, WiFi, Bluetooth, RFID or other similar non-contact interface. This embodiment does not implement the external physical contacts for a control signal to initiate the user authentication process and apply electrical power as the pinning source to execute the authentication algorithm. Electrical power is provided either by electromagnetic coupling or provided by an internal battery source.

In another preferred embodiment, the fingerprint-sensing device has a base (such as a thin film printed circuit board), and is either built into or placed upon the base in the preferred embodiment, but does not occupy the entire area. The base embodiment also contains a microprocessor integrated circuit, memory integrated circuit(s), a thin film battery, miscellaneous discrete components, and contact pads for the purpose of electrical interface with an external connector. The contact pads are disposed at the appropriate location on the top surface of the base and a cut out section in top surface aligns with the base contact pad to electrically connect the corresponding external interconnect leads. An interconnect structure establishes electrical connections between the various integrated circuits, components, in the base printed circuit board.

The interior base layer includes a thin film battery for retaining critical stored data values in the volatile memory integrated circuit, for operation of tamper sensing circuitry for volatile memory, to execute microprocessor functions, to execute zeroization of temporary memory values, and to execute zeroization of critical volatile memory upon tamper sensing events with the absence of outside electrical power.

As a result and limitations of the electrical output capacity of the thin film integrated battery, the preferred embodiment does not, in principle, use this electrical supply to execute authentication, encryption, and general microprocessor functions. In general, the thin film battery is intended to supply electrical power for two functions for the preferred embodiment: (1) the holding and protecting critical data values for the user of the secure token like credentialing data, biometric, templates, and cryptographic certificates, and (2) to secure token output circuitry executed on the printed circuit board, for execution of a secure transaction or payment. Protecting sensor circuitry is electrically powered by the thin film battery including the reference biasing circuitry. When a sensor event of sufficient magnitude is detected, an output signal is generated which results in zeroization of all or part of data stored in non-volatile memory.

While these preferred embodiments with the operating conditions have been described above to obtain optimum performance and user convenience for a secure authentication token, an alternative embodiment has a similar multi-layer stack and includes a ferromagnetic coil structure and circuitry to magnetically couple power to the base circuitry in addition to outputting data signals magnetically. Under the application of a sufficient magnet field applied from an external source, the contact interface can be replaced by a non-contact magnetic interface.

For initiation and execution of a secure transaction, the secure token is inserted into a portable commercial MP3 player. The secure token also can be connected to any commercial portable device such as a MP3 player, PDA, cellular phone, laptop, or similar device for performing secure transactions.

In one secure transaction embodiment, electrical power and initiation of secure transaction enabling electrical signal begins upon connection and contact through a 30-pin connector, USB, serial, and or any other electrical interface. In general, the contact between the two connectors or electrodes closes an electrical circuit in the secure token allowing the self-authentication process within the secure token to be executed. In this manner, the user is positively matched to the secure token. Similarly, if the user does not pass the biometrical authentication process, the user is denied access to critical data stored within the secure token and electrical communications and power are disabled from the portable mobile device.

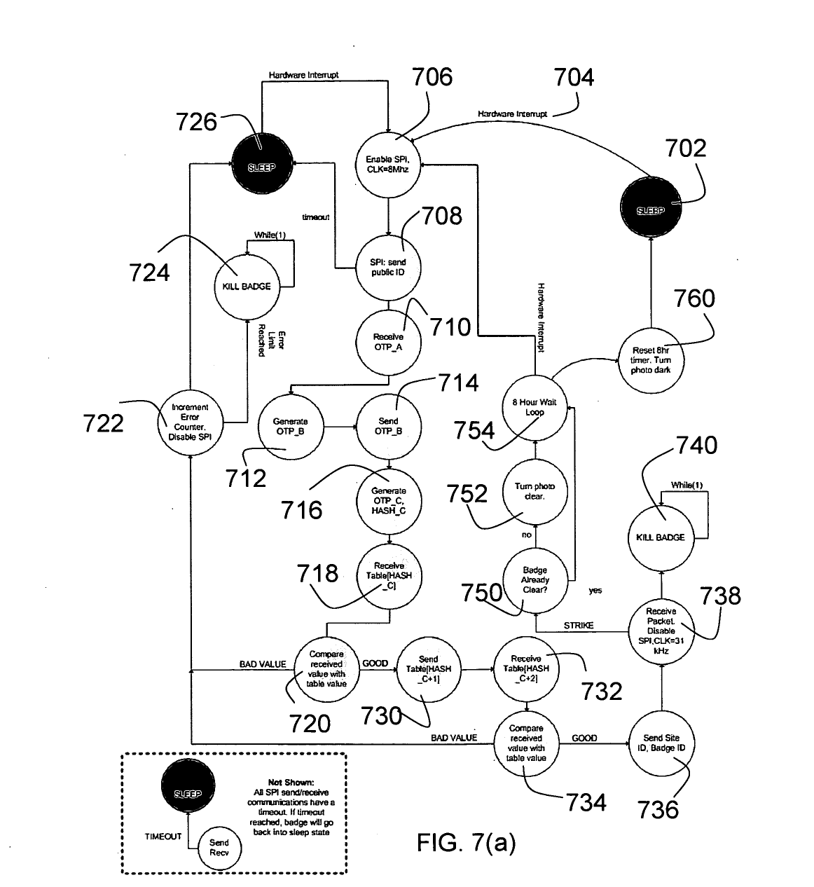

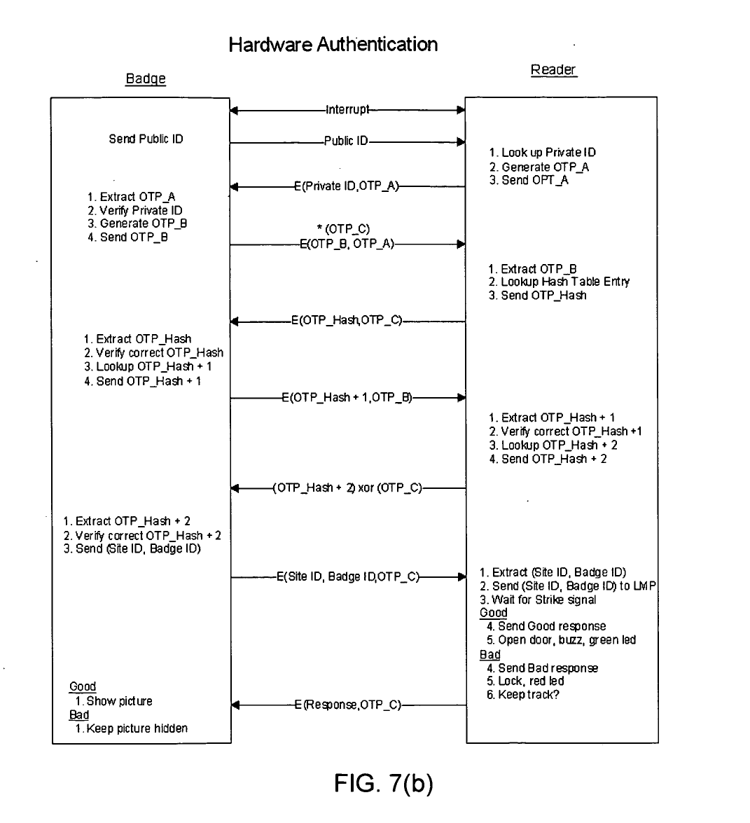

A preferred embodiment of a system and method for authentication of a badge, card or token in accordance with the present invention is described with reference to FIGS. 7 and 8. When the card is in an “inactive” or “unauthenticated” state, the card is generically speaking in a “sleep” state 702. When the badge is coupled with a reader, a hardware interrupt 704 causes the clock on the card to be enabled 706. The badge then sends a public ID to the reader 706. After receiving the public ID from the badge, the reader looks up a private ID, generates the signal OTP_A and sends the signal to the badge. The badge receives the signal OTP_A 710, verifies the private ID, generates a response signal OTP_B 712 and sends the signal OTP_B to the reader 714. The reader receives the signal OTP_B, generates a signal OTP_C 716, looks up a hash table entry and sends a hash signal HASH_C to the badge. The badge receives the signal HASH_C 718 and compares the received value with a table value stored on the badge 720. If the values do not match, an error counter is incremented 722 and the badge is returned to sleep mode 726 until the next hardware interrupt.

If the values match, the badge send a signal HASH_C+1 to the reader 730. The reader verifies that the correct HASH_C+1 has been received, looks up HASH_C+2 and sends that signal to the badge. The badge receives HASH_C+2 732 and compares the received value with a table value 734. If the values do not match, the error counter is incremented and the card returns to sleep mode until the next hardware interrupt. If the values match, the badge sends a site ID and badge ID to the reader 736. The reader receives the site ID and badge ID from the badge, sends them to LMP and waits for a strike signal. If the badge is not verified, the reader sends a “Bad” response to the badge. If the badge is verified, the reader sends a “Good” signal to the badge. The badge receives the signal from the reader 738. If the signal indicates “Bad,” the badge is killed 740, which permanently disables the badge. If the signal indicates the badge is “Good,” the badge determines whether the window 110 is already clear 750. If not, the window 110 is turned clear 752 and the timer is started 754. If the badge is already clear, the timer is restarted.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A secure token comprising:
a substrate layer having an interface therein;
a tamper layer comprising a conductive tamper pattern;
a flex circuit layer comprising a microprocessor, a memory, a timer and a battery, said memory, timer, tamper pattern and interface being connected to said microprocessor and said timer being connected to said battery; and
a smart window layer having a transparent state and an opaque state, wherein said smart window layer changes between said transparent and opaque states with the application of a voltage.

2. A secure token according to claim 1, further comprising a transparent PVC layer having information printed thereon and said a portion of said printed information is at least partially obscured when said smart window layer is in said opaque state and is visible when said smart window is in said transparent state.

3. A secure token according to claim 2, wherein said smart window comprises a plurality of window sections, each window section being independently controllable to switch between transparent and opaque states and wherein information printed on portions of said PVC layer overlying each window section is visible when said window section is in its transparent state and is at least partially obfuscated when said window section is in its opaque state.

4. A secure token according to claim 2 further comprising a holographic layer having a holograph thereon.

5. A secure token according to claim 1, wherein said tamper layer and said flex circuit layer are on a first portion of said substrate layer and said smart window layer is on a second portion of said substrate layer.

6. A secure token according to claim 1, wherein said smart window layer has information printed thereon and said printed information is at least partially obscured when said smart window layer is in said opaque state and is visible when said smart window is in said transparent state.

7. A secure token according to claim 6, wherein said smart window comprises a plurality of window sections, each window section being independently controllable to switch between transparent and opaque states and wherein information printed on each window section is visible when said window section is in its transparent state and is at least partially obfuscated when said window section is in its opaque state.

8. A secure token according to claim 1, wherein said flex circuit layer further comprises a timer, said timer being started when said smart window layer is changed from said opaque state to said transparent state and when said timer reaches a predetermined threshold, said smart window layer is automatically changed from said transparent state to said opaque state.

9. A secure token according to claim 1 further comprising a biometric sensor mounted to said secure token and connected to said microprocessor.

10. A secure token according to claim 9 wherein said biometric sensor comprises a fingerprint reader.

11. A secure token according to claim 10 wherein said fingerprint reader is mounted to said flex circuit layer and protrudes through an opening in said window layer.

12. A secure token according to claim 1, wherein said flex circuit layer further comprises an encryptor/decryptor connected to said microprocessor and said battery.

13. A secure token according to claim 1, wherein said smart window further comprises means for creating a visible void in said smart window layer.

14. A secure token according to claim 1 further comprising a holographic layer having a holograph thereon.

15. A secure token according to claim 1, wherein said conductive tamper pattern comprises a serpentine pattern.

16. A smartcard according to claim 1, wherein said interface comprises a contact interface.

17. A smartcard according to claim 1, wherein said microprocessor comprises an encryptor and a decryptor.

18. A smartcard according to claim 1 wherein said smart window layer comprises an electrophoretic layer.

19. A smartcard according to claim 1 wherein said electrophoretic layer comprises an electrical circuit layer, an electrophoretic material, and a transparent plastic layer.

20. A smartcard according to claim 1 wherein said smart window layer comprises an electrochromic material.

21. A smartcard according to claim 1, wherein said microprocessor comprises means for sending a pulse through said conductive tamper pattern and means for detecting a pulse sent through said tamper pattern.

22. A secure token comprising:
a housing;
a window layer on a portion of said housing, said window layer having a substantially transparent state and a substantially opaque state; and
means for controlling said window layer to change between said transparent and opaque states;
wherein said window layer at least partially obfuscates printed data when said laminate is opaque and does not obfuscate said printed data when said laminate is in said transparent state.

23. A secure token according to claim 22 wherein said printed data is printed on said window layer.

24. A secure token according to claim 22 wherein said printed data is printed on said housing.

25. A secure token according to claim 22, further comprising a microprocessor, a contact, and a biometric sensor mounted in said housing.

26. A secure token according to claim 25, further comprising means for performing authentication within said secure token.

27. A secure token according to claim 26, further comprising a battery for providing power to said microprocessor, said window layer and said biometric sensor.

28. A secure token according to claim 26, where said biometric sensor comprises a fingerprint reader mounted in a recess in said housing.

29. A secure token according to claim 22, wherein said housing is in the shape of a credit card and has front and back sides.

30. A secure token according to claim 22, further comprising an interface.

31. A secure token according to claim 30, wherein said interface comprises one selected from the group of: an RFID interface, a USB port, and a 30-pin bipod type connector, and a six-pin smartcard interface.
